(19) United States
(12) Patent Application Publication
(10) Pub. No.: US 2022/0248506 A1
(43) Pub. Date: Aug. 4, 2022

(54) INDUCTION HEATING APPARATUS AND METHOD FOR CONTROLLING THE SAME

(71) Applicant: LG Electronics Inc., Seoul (KR)

(72) Inventors: Byeong Geuk Kang, Seoul (KR); Younseok Jang, Seoul (KR)

(21) Appl. No.: 17/588,909

(22) Filed: Jan. 31, 2022

(30) Foreign Application Priority Data
Feb. 3, 2021 (KR) 10-2021-0015709

(51) Int. Cl. H05B 6/06; H05B 6/04; H05B 6/12

(52) U.S. Cl. CPC H05B 6/065; H05B 6/1209; H05B 6/04

(57) ABSTRACT

The induction heating apparatus includes a current conversion circuit, a first working coil whose one end is connected to the current conversion circuit, a second working coil whose one end is connected to the current conversion circuit or the other end of the first working coil, a working coil base that accommodates the first working coil and the second working coil, a resonance capacitor that connects to the other end of the second working coil, a first relay that adjusts a connection between the other end of the first working coil and the resonance capacitor, a second relay that selectively connects one end of the second working coil to any one of the other end of the first working coil and the current conversion circuit, and a controller that controls the first relay's and the second relay's connections.

### CROSS-REFERENCE TO RELATED APPLICATION

This application claims priority to and benefit of Korean Patent Application No. 10-2021-0015709, filed on Feb. 3, 2021, the disclosure of which is incorporated herein by reference in its entirety.

### BACKGROUND

### 1. Field

Disclosed herein is an induction heating apparatus and a method for controlling the same.

### 2. Background

Various types of cooking apparatuses are used at homes and restaurants to heat food items. Gas ranges that use gas as a fuel have been widely used as one of the cooking apparatuses. Apparatuses are available that heat an object to be heated (e.g., a cooking container comprising a pot) by using electricity rather than gas.

Among methods of heating an object to be heated with electricity, induction heating involves generating eddy current in an object to be heated made of metal (e.g., a cooking container) with a magnetic field that is generated around a coil when high-frequency power having predetermined magnitude is supplied to the coil, such that the object to be heated itself is heated. An induction heating apparatus to which induction heating is applied is ordinarily provided with a working coil in a heating zone (or heating region) in which an object to be heated is placed (or provided) and heated.

For the induction heating apparatus, a plurality of working coils is disposed in a single heating zone to heat an object to be heated, as disclosed in Korean Patent Publication No. 10-2019-0083879, the subject matter of which is incorporated herein by reference. As in the above document, the induction heating apparatus includes the plurality of working coils of different sizes, so that some of the plurality of working coils cannot be used depending on the size of an object to be heated. Additionally, the plurality of working coils are connected to one another in parallel. Thus, it may be difficult to adjust the outputs of the plurality of working coils differently, causing deterioration in the efficiency of a current supply circuit that supplies current to the working coils.

### BRIEF DESCRIPTION OF THE DRAWINGS

Arrangements and embodiments may be described in detail with reference to the following drawings in which like reference numerals refer to like elements and wherein:

FIG. 1 is a circuit diagram showing an induction heating apparatus of one embodiment;

FIG. 2 is a view showing a working coil and a working coil base of the induction heating apparatus of one embodiment;

FIG. 3 is an enlarged view showing portion “A” in FIG. 2 when a first working coil and a second working coil of the induction heating apparatus of one embodiment are coupled to each other as a Litz wire structure;

FIG. 4 is a cross-section view along line “B” in FIG. 2 when the first working coil is disposed on or under the second working coil in the induction heating apparatus of one embodiment;

FIG. 5 is a cross-sectional view along line “B” in FIG. 2 when the first working coil and the second working coil are accommodated in the working coil base 140 in a way that a turn of the first working coil and a turn of the second working coil are alternately placed, in the induction heating apparatus of one embodiment;

FIG. 6 is a circuit diagram showing connections of a first relay and a second relay for operating the second working coil only in the induction heating apparatus of one embodiment;

FIG. 7 is a circuit diagram showing connections of the first relay and the second relay for connecting and operating the first working coil and the second working coil in parallel in the induction heating apparatus of one embodiment;

FIG. 8 is a circuit diagram showing connections of the first relay and the second relay for connecting and operating the first working coil and the second working coil in series in the induction heating apparatus of one embodiment;

FIG. 9 is a graph showing outputs of the induction heating apparatus based on frequencies of currents supplied through a current conversion circuit when a ferromagnetic object to be heated is placed on the induction heating apparatus of one embodiment;

FIG. 10 is a graph showing outputs of the induction heating apparatus based on frequencies of currents supplied through a current conversion circuit when an anti-ferromagnetic object to be heated is placed on the induction heating apparatus of one embodiment; and

FIG. 11 is a flow chart showing a method for controlling the induction heating apparatus of one embodiment.

### DETAILED DESCRIPTION

The above-described aspects, features and advantages are specifically described hereunder with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague. Preferred embodiments according to the disclosure are specifically described with reference to the accompanying drawings. In the drawings, identical reference numerals can denote identical or similar components.

An induction heating apparatus and a method for controlling the same in several embodiments is described.

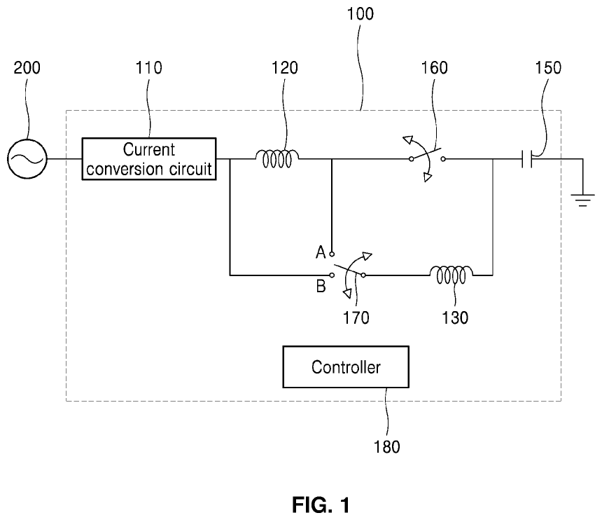

FIG. 1 is a circuit diagram showing an induction heating apparatus of one embodiment. An induction heating apparatus 100 of one embodiment includes a current conversion circuit 110, a first working coil 120, a second working coil 130, a resonance capacitor 150, a first relay 160 (or first relay circuit), a second relay 170 (or second relay circuit) and a controller 180. Although not shown in FIG. 1, the induction heating apparatus 100 of one embodiment may include a working coil base 140.

The current conversion circuit 110 converts current supplied by an external power source 200 (or power supply). The current conversion circuit 110 may convert current supplied from the external power source 200 to current having a target frequency, and output the current having the target frequency to the first working coil 120 and/or the second working coil 130 that are described hereafter.

The target frequency is a frequency of current that needs to be output to the first working coil 120 and/or the second working coil 130 by the current conversion circuit 110 such that the induction heating apparatus outputs heat corresponding to a target output value through the first working coil 120 and the second working coil 130.

The target frequency (or target frequency value) may correspond to an amount of heat energy to be output through the first working coil 120 and the second working coil 130, and may be set, by a user, through an interface (or interface unit) included in the induction heating apparatus 100.

The current conversion circuit 110 may convert current, supplied from the external power source 200 through a rectifying circuit, an inverter circuit, a smoothing capacitor and/or the like, to current having a target frequency, and output the current having the target frequency.

An object to be heated (e.g., a cooking container) may be disposed at an upper side of the first working coil 120. The first working coil 120 heats the object to be heated through resonance current generated between the first working coil 120 and the object to be heated, as the current flows. The first working coil 120 may be supplied with current from the current conversion circuit 110.

One end of the first working coil 120 connects to the current conversion circuit 110. Additionally, the other end of the first working coil 120 may connect to the second working coil 130 or the resonance capacitor 150.

An object to be heated may be disposed at the upper side of the second working coil 130. The second working coil 130 heats the object to be heated through resonance current generated between the second working coil 130 and the object to be heated, as the current flows. The second working coil 130 may be supplied with current from the current conversion circuit 110.

One end of the second working coil 130 connects to the other end of the current conversion circuit 110 or to the first working coil 120. Additionally, the other end of the second working coil 130 may connect to the resonance capacitor 150.

The working coil base 140 is a structure that accommodates the first working coil 120 and the second working coil 130. The working coil base 140 may be made of a non-conductive material.

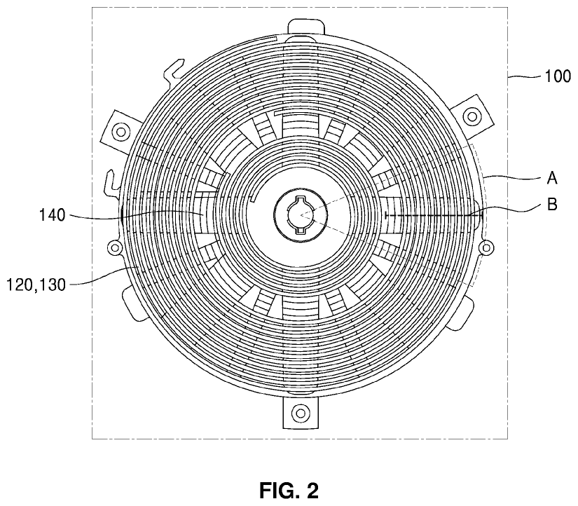

A structure in which the first working coil 120 and the second working coil 130 are accommodated on the working coil base 140 (or in the working coil base) is specifically described with reference to FIGS. 2 to 5.

FIG. 2 is a view showing a working coil and a working coil base of the induction heating apparatus of one embodiment. FIG. 2 shows the first working coil 120 and the second working coil 130 accommodated on the working coil base 140. The first working coil 120 and the second working coil 130 may sit on the working coil base 140, and may be wound a plurality of times. That is, the first working coil 120 and the second working coil 130 may include a plurality of turns.

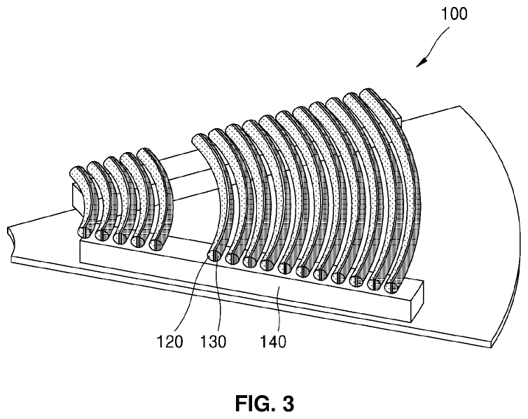

The first working coil 120 and the second working coil 130 may be coupled to each other as a Litz wire structure, in a first embodiment. FIG. 3 provides an illustration of this structure.

FIG. 3 is an enlarged view showing portion “A” of FIG. 2 when a first working coil and a second working coil of the induction heating apparatus are coupled to each other as a Litz wire structure.

FIG. 3 shows a partial area of the portion in which the first working coil 120 and the second working coil 130 are accommodated on the working coil base 140. In this example, a turn of the first working coil 120 and a turn of the second working coil 130 are combined and form a signal turn.

The turn of the first working coil 120 and the turn of the second working coil 130 may be coupled as a Litz wire structure. That is, the turns of the first working coil 120 and the second working coil 130 may include a plurality of wires respectively, and the outer surfaces of the plurality of wires may be coated with an insulating layer.

In an example in which the first working coil 120 and the second working coil 130 are insulated from each other, the turn of the first working coil 120 and the turn of the second working coil 130 are combined as a single turn, such that the first working coil 120 and the second working coil 130 are placed (or provided) within the same area range of the working coil base 140. Accordingly, the first working coil 120 and the second working coil 130 may heat an object to be heated within the same area range, and the user may use all the working coils 120, 130, regardless of the size of the object to be heated.

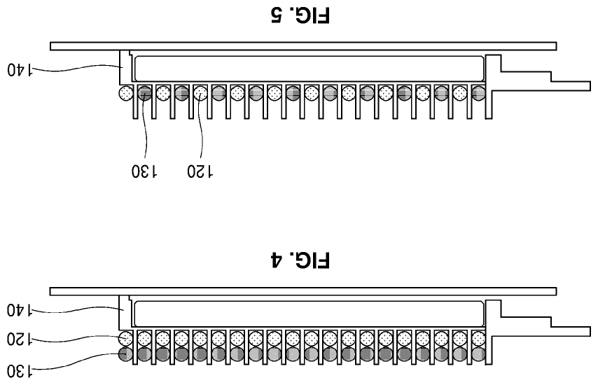

Referring back to FIG. 2, the first working coil 120 may be accommodated on the working coil base 140 such that the first working coil 120 is disposed on or under the second working coil 130, in a second embodiment. FIG. 4 shows such an illustration.

FIG. 4 is a cross-section view along line “B” of FIG. 2 when the first working coil 120 is disposed on or under the second working coil 130 in the induction heating apparatus.

FIG. 4 shows a cross section of a partial area of the portion in which the first working coil 120 and the second working coil 130 are accommodated on the working coil base 140. In this example, a turn of the first working coil 120 may be disposed under a turn of the second working coil 130. That is, the first working coil 120 is accommodated in (or on) the working coil base 140, and then the second working coil 130 is disposed on the first working coil 120. In this example, the outer surfaces of the first working coil 120 and the second working coil 130 may be coated with an insulating layer.

Since the first working coil 120 is disposed under the second working coil 130 as described above, the first working coil 120 and the second working coil 130 may be placed (or provided) in the same area range of the working coil base 140. Accordingly, the first working coil 120 and the second working coil 130 may heat an object to be heated in the same area range, and the user may use all the working coils 120, 130 regardless of the size of the object to be heated.

FIG. 4 shows an embodiment in which the first working coil 120 is disposed under the second working coil 130. However, in another embodiment, the second working coil 130 may be disposed under the first working coil 120.

Referring back to FIG. 2, the first working coil 120 and the second working coil 130 may be accommodated on the working coil base 140 such that a turn of the first working coil 120 and a turn of the second working oil 130 are alternately provided, in a third embodiment. FIG. 5 shows such an illustration.

FIG. 5 is a cross-sectional view along line “B” of FIG. 2 when the first working coil 120 and the second working coil 130 are accommodated on the working coil base 140 such that a turn of the first working coil and a turn of the second working coil are alternately provided, in the induction heating apparatus of one embodiment.

FIG. 5 shows a cross section of a partial area of the portion in which the first working coil 120 and the second working coil 130 are accommodated on the working coil base 140. In this example, a turn of the first working coil 120 and a turn of the second working coil 130 may be alternately provided. That is, a turn of the first working coil 120 may be disposed between turns of the second working coil 130. Additionally, a turn of the second working coil 130 may be disposed between turns of the first working coil 120.

Since a turn of the first working coil 120 and a turn of the second working coil 130 are alternately provided, the first working coil 120 and the second working coil 130 may be provided in the same area range of the working coil base 140. Accordingly, the first working coil 120 and the second working coil 130 may heat an object to be heated in the same area range, and the user may use all the working coils 120, 130 regardless of the size of the object to be heated.

Referring back to FIG. 1, the resonance capacitor 150 may connect to the other end of the second working coil 130. The resonance capacitor 150 forms a resonance circuit together with at least one of the first working coil 120 and the second working coil 130. Thus, the resonance current is generated among the first working coil 120, the second working coil 130, and the object to be heated, and thus the object to be heated is heated.

The first relay 160 (or first relay circuit) is disposed between the first working coil 120 and the resonance capacitor 150. The first relay 160 adjusts a connection between the other end of the first working coil 120 and the resonance capacitor 150. As the first relay 160 is turned on or turned off, the first relay 160 connects between the first working coil 120 and the resonance capacitor 150 or disconnects the first working coil 120 from the resonance capacitor 150. The first relay 160 may be a Single Pole Single Throw (SPST) relay that has two contact points for one switch. Connection of the first relay 160 is controlled by the controller 180 as will be described below.

The second relay 170 selectively connects one end of the second working coil 130 to any one of the other end of the first working coil 120 and the current conversion circuit 110. That is, the second relay 170 adjusts an object to which the second working coil 130 is to connect. In this example, the second relay 170 connects to contact point A or to contact point B, and connects one end of the second working coil 130 to the other end of the first working coil 120 or the current conversion circuit 110. The second relay 170 may be a Single Pole Double Throw (SPDT) relay that has three contact points for one switch. Connection of the second relay 170 is controlled by the controller 180 as will be described below.

The controller 180 may control entire operation of the induction heating apparatus 100. The controller 180 may be implemented to include a physical element including at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), controllers, micro-controllers, and microprocessors.

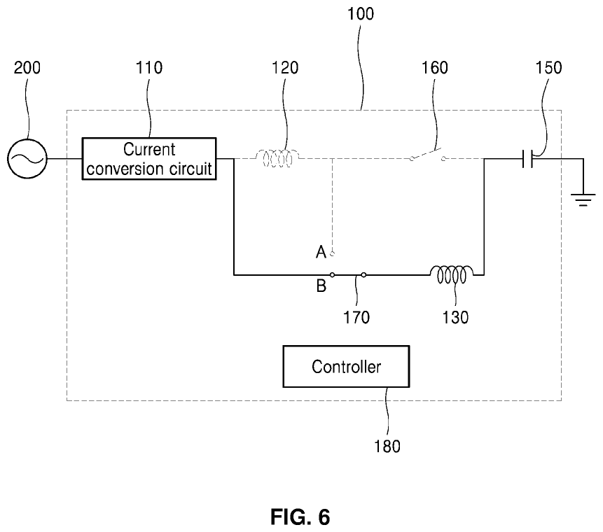

The controller 180 may control connections of the first relay 160 and the second relay 170. In this example, the controller 180 controls the connections of the first relay 160 and the second relay 170 such that the second working coil 130 only operates, the first working coil 120 and the second working coil 130 connect and operate in parallel, or the first working coil 120 and the second working coil 130 connect and operate in series. A detailed description in relation to this is provided with reference to FIGS. 6 to 8.

FIG. 6 is a circuit diagram showing connections of a first relay and a second relay for operating the second working coil only in the induction heating apparatus of one embodiment. Referring to FIG. 6, the controller 180 controls the first relay 160 such that the first relay 160 does not connect between the other end of the first working coil 120, and the resonance capacitor 150. The controller 180 controls the second relay 170 such that the second relay 170 connects between one end of the second working coil 130 and the current conversion circuit 110. Accordingly, the current conversion circuit 110 and the resonance capacitor 150 may connect to each other only through the second working coil 130. The controller 180 turns off the first relay 160 and controls the second relay 170 such that the second relay 170 connects to contact point B, thereby making it possible to operate the second working coil 130 only.

The above-described control of operating the second working coil 130 only is similar to the below-described control of connecting and operating the first working coil 120 and the second working coil 130 in parallel, but likely generates heat. Thus, the control of operating the second working coil 130 only may not be used.

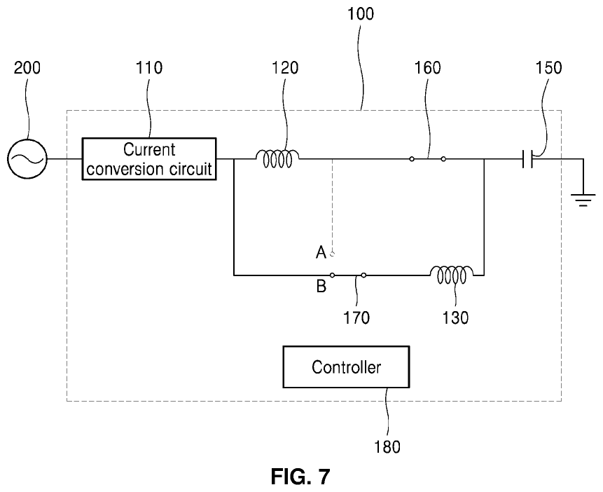

FIG. 7 is a circuit diagram showing connections of the first relay and the second relay for connecting and operating the first working coil and the second working coil in parallel in the induction heating apparatus of one embodiment. Referring to FIG. 7, the controller 180 controls the first relay 160 such that the first relay 160 connects between the other end of the first working coil 120 and the resonance capacitor 150. The controller 180 controls the second relay 170 such that the second relay 170 connects between one end of the second working coil 130 and the current conversion circuit 110. Accordingly, the current conversion circuit 110 and the resonance capacitor 150 may connect to each other through the first working coil 120 and the second working coil 130. In this example, the first working coil 120 and the second working coil 130 connect in parallel between the current conversion circuit 110 and the resonance capacitor 150.

The controller 180 turns on the first relay 160 and controls the second relay 170 such that the second relay 170 connects to contact point B, thereby making it possible to connect and operate the first working coil 120 and the second working coil 130 in parallel.

As the first working coil 120 and the second working coil 130 connect and operate in parallel, the resistance and inductance of all the working coils decrease. Accordingly, output of the induction heating apparatus 100 increases. That is, the control of a parallel connection between the first working coil 120 and the second working coil 130 can be useful when a high output is required.

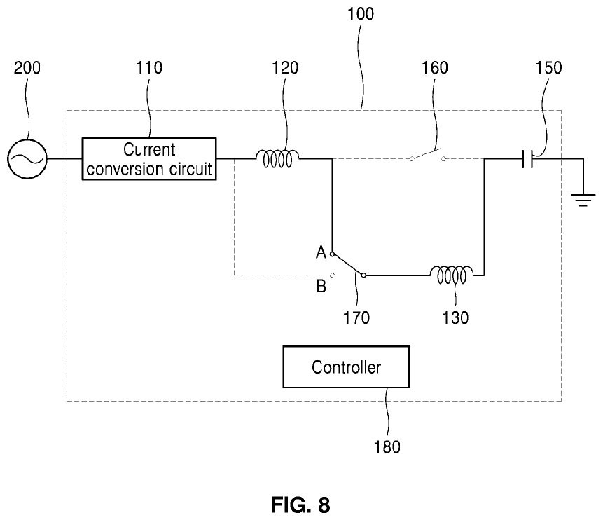

FIG. 8 is a circuit diagram showing connections of the first relay and the second relay for connecting and operating the first working coil and the second working coil in series in the induction heating apparatus of one embodiment.

Referring to FIG. 8, the controller 180 controls the first relay 160 such that the first relay 160 does not connect between the other end of the first working coil 120 and the resonance capacitor 150. The controller 180 controls the second relay 170 such that the second relay 170 connects between one end of the second working coil 130 and the other end of the first working coil 120. Accordingly, the current conversion circuit 110 and the resonance capacitor 150 may connect to each other through the first working coil 120 and the second working coil 130. In this example, the first working coil 120 and the second working coil 130 connect in series between the current conversion circuit 110 and the resonance capacitor 150.

The controller 180 turns off the first relay 160 and controls the second relay 170 such that the second relay 170 connects to contact point A, thereby making it possible to connect and operate the first working coil 120 and the second working coil 130 in series.

As the first working coil 120 and the second working coil 130 connect and operate in series, the resistance and inductance of all the working coils increase. Accordingly, the output of the induction heating apparatus 100 decreases. However, since a range of driving frequencies supplied through the current conversion circuit 110 may increase, the output may be controlled more precisely. Thus, the control of a series connection between the first working coil 120 and the second working coil 130 can be useful when a low output is required.

Referring back to FIG. 1, the controller 180 may control connections of the first relay 160 and the second relay 170, based on at least one of a type (or sort) of an object to be heated (that is provided on the induction heating apparatus 100) and a target output value.

In one embodiment, the controller 180 may receive an input corresponding to the type of the object to be heated from the user through the interface (or interface unit) disposed at the induction heating apparatus 100, and determine (or determine) the type (or sort) of the object to be heated based on the received input. In another embodiment, the controller 180 may supply current of a specific frequency to the first working coil 120 and the second working coil 130 through the current conversion circuit 110, and analyze the output of the first working coil 120 and the second working coil 130, to determine the type (or determine the sort) of the object to be heated.

Additionally, the controller 180 may receive an input corresponding to a target output value from the user through the interface (or interface unit) disposed at the induction heating apparatus 100, and determine (or determine) the target output value based on the received input.

The controller 180 may control the first relay 160 such that the first relay 160 connects between the other end of the first working coil 120 and the resonance capacitor 150, and control the second relay 170 such that the second relay 170 connects between one end of the second working coil 130 and the current conversion circuit 110, when the object to be heated placed on the induction heating apparatus 100 is made of a ferromagnetic material and when the target output value is a predetermined reference output value or greater. That is, the controller 180 may connect and operate the first working coil 120 and the second working coil 130 in parallel, when the object to be heated placed on the induction heating apparatus 100 is made of a ferromagnetic material and when the target output value is the reference output value or greater.

Additionally, the controller 180 may control the first relay 160 such that the first relay 160 does not connect between the other end of the first working coil 120 and the resonance capacitor 150, and control the second relay 170 such that the second relay 170 connects between one end of the second working coil 130 and the other end of the first working coil 120 when the object to be heated placed on the induction heating apparatus 100 is made of a ferromagnetic material and when the target output value is less than the reference output value. That is, the controller 180 may connect and operate the first working coil 120 and the second working coil 130 in series when the object to be heated placed on the induction heating apparatus 100 is made of a ferromagnetic material and when the target output value is less than the reference output value.

The controller 180 may control the first relay 160 such that the first relay 160 does not connect between the other end of the first working coil 120 and the resonance capacitor 150, and control the second relay 170 such that the second relay 170 connects between one end of the second working coil 130 and the other end of the first working coil 120 when the object to be heated placed on the induction heating apparatus 100 is made of a non-ferromagnetic material. That is, the controller 180 may connect and operate the first working coil 120 and the second working coil 130 in series when the object to be heated placed on the induction heating apparatus 100 is made of an anti-ferromagnetic material.

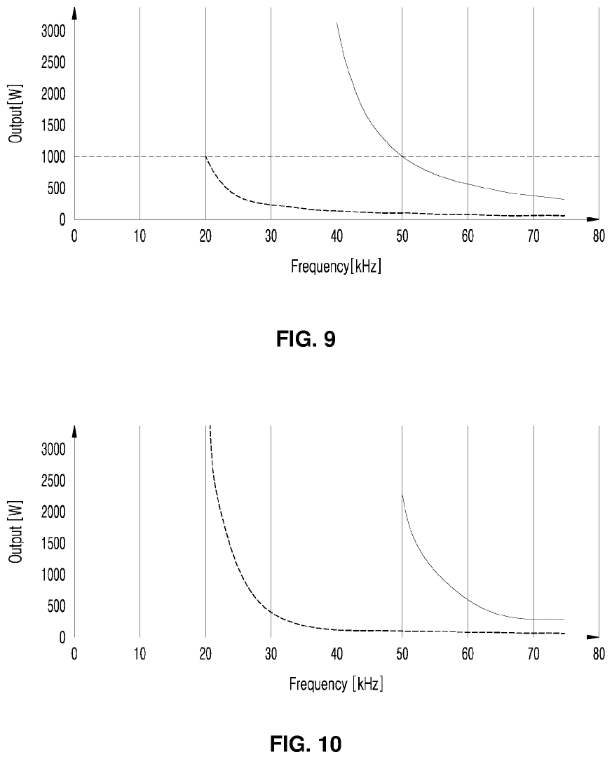

The reason for the above-described control is given with reference to FIGS. 9 and 10. FIG. 9 is a graph showing outputs of the induction heating apparatus based on frequencies of currents supplied through a current conversion circuit when an object to be heated that is placed on the induction heating apparatus of one embodiment is made of a ferromagnetic material.

FIG. 9 shows a graph of outputs of the induction heating apparatus 100, based on frequencies of currents supplied through the current conversion circuit 110 when a ferromagnetic object to be heated is placed on the induction heating apparatus 100. In the graph, the solid line shows outputs of the induction heating apparatus 110 when the first working coil 120 and the second working coil 130 connect and operate in parallel, and the dashed line shows outputs of the induction heating apparatus 100 when the first working coil 120 and the second working coil 130 connect and operate in series.

Referring to the graph, when the first working coil 120 and the second working coil 130 connect and operate in series, a maximum output of the induction heating apparatus 100 is about 1000 W, and when the first working coil 120 and the second working coil 130 connect and operate in parallel, a maximum output of the induction heating apparatus 100 is about 3000 W. Thus, the controller 180 may connect and operate the first working coil 120 and the second working coil 130 in parallel, when the target output value is 1000 W or greater in the case of a ferromagnetic object to be heated. In the embodiment of FIG. 9, the reference output value may be 1000 W.

Additionally, the controller 180 may output the target output value regardless of the state in which the first working coil 120 and the second working coil 130 connect in parallel or in series, when the target output value is less than 1000 W in the case of a ferromagnetic object to be heated. When the first working coil 120 and the second working coil 130 connect and operate in series, the output may be adjusted within a wider range of frequencies, thereby making it possible to control the output more precisely. Further, the series connection between the first working coil 120 and the second working coil 130 may result in the same output as the parallel connection between the first working coil 120 and the second working coil 130, at currents of lower frequencies, thereby ensuring improvement in the efficiency of the current conversion circuit 110.

Thus, when the target output value is less than 1000 W in the case of a ferromagnetic object to be heated, the controller 180 may connect and operate the first working coil 120 and the second working coil 130 in series.

FIG. 10 is a graph showing outputs of the induction heating apparatus based on frequencies of currents supplied through a current conversion circuit when an anti-ferromagnetic object to be heated is placed on the induction heating apparatus of one embodiment. FIG. 10 shows a graph of outputs of the induction heating apparatus 100, based on frequencies of currents supplied through the current conversion circuit 110 when an anti-ferromagnetic object to be heated is placed on the induction heating apparatus 100. In the graph, the solid line shows outputs of the induction heating apparatus 100 when the first working coil 120 and the second working coil 130 connect and operate in parallel, and the dashed line shows outputs of the induction heating apparatus 100 when the first working coil 120 and the second working 130 connect and operate in series.

Referring to the graph, a maximum output in the series connection between the first working coil 120 and the second working coil 130 may be greater than in the parallel connection between the first working coil 120 and the second working coil 130. Further, the series connection may result in the same output as the parallel connection, at currents of lower frequencies, thereby ensuring improvement in the efficiency of the current conversion circuit 110.

Thus, in the case of an anti-ferromagnetic object to be heated, the controller 180 may connect and operate the first working coil 120 and the second working coil 130 in series.

Since the connection between the first working coil 120 and the second working coil 130 is adjusted depending on the type of an object to be heated, as described above, the induction heating apparatus 100 may adjust outputs differently and help to improve the efficiency of the current conversion circuit 110.

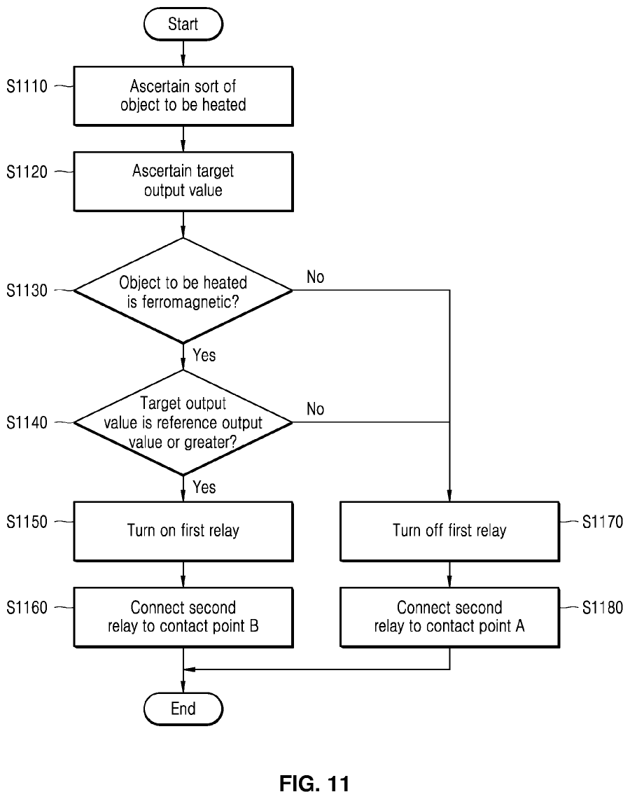

FIG. 11 is a flow chart showing a method for controlling the induction heating apparatus of one embodiment. Referring to FIG. 11, the controller 180 determines the sort (or determines the type) of an object to be heated that is placed on the induction heating apparatus 100 (S1110). In one embodiment, the controller 180 may receive an input from the user corresponding to the type of the object to be heated through the interface (or interface unit) disposed at the induction heating apparatus 100, and based on the received input, determine the type of the object to be heated. In another embodiment, the controller 180 may supply current of a specific frequency to the first working coil 120 and the second working coil 130 through the current conversion circuit 110, and analyze the output of the first working coil 120 and the second working coil 130, to determine the type of the object to be heated.

The controller 180 may determine a target output value (S1120). In this case, the controller 180 may receive an input (from a user) corresponding to the target output value through the interface (or interface unit) disposed at the induction heating apparatus 100, and based on the received input, determine the target output value.

The controller 180 may then determine whether the object to be heated that is placed on the induction heating apparatus 100 is a ferromagnetic object to be heated (S1130). When the object to be heated (that is placed on the induction heating apparatus 100) is a ferromagnetic object to be heated, the controller 180 determines whether the target output value is the reference output value or greater (S1140).

When the target output value is the reference output value or greater, the controller 180 turns on the first relay 160 (S1150). That is, the first controller 180 controls the first relay 160 such that the first relay 160 connects between the first working coil 120 and the resonance capacitor 150.

Additionally, when the target output value is the reference output value or greater, the controller 180 controls the second relay 170 such that the second relay 170 connects to contact point B (S1160). That is, the controller 180 controls the second relay 170 such that the second relay 170 connects between one end of the second working coil 130 and the current conversion circuit 110.

That is, when the object to be heated (provided on the induction heating apparatus 100) is a ferromagnetic object to be heated and when the target output value is the reference output value or greater, the controller 180 connects and operates the first working coil 120 and the second working coil 130 in parallel.

When determining that the object to be heated (provided on the induction heating apparatus 100) is not a ferromagnetic object to be heated in operation 1130 (S1130) or when determining that the target output value is not the reference output value or greater in operation 1140 (S1140), the controller 180 turns off the first relay 160 (S1170). That is, the controller 180 controls the first relay 160 such that the first relay 160 does not connect between the first working coil 120 and the resonance capacitor 150.

When determining that the object to be heated (provided on the induction heating apparatus 100) is not a ferromagnetic object to be heated in operation 1130 (S1130) or when determining that the target output value is not the reference output value or greater in operation 1140 (S1140), the controller 180 controls the second relay 170 such that the second relay 170 connects to contact point A (S1180). That is, the controller 180 controls the second relay 170 such that the second relay 170 connects between one end of the second working coil 130 and the other end of the first working coil 120.

That is, when the object to be heated (provided on the induction heating apparatus 100) is an anti-ferromagnetic object, the controller 180 connects and operates the first working coil 120 and the second working coil 130 in series.

In the induction heating apparatus 100 and the method for controlling the same 100 according to the disclosure, since the first working coil 120 and the second working coil 130 are accommodated on a single working coil base 140, as described above, all the working coils 120, 130 can be used regardless of the size of an object to be heated. Further, the connections of the first relay 160 and the second relay 170 can change based on at least one of the type of an object to be heated and a target output value, to change a connection relationship between the first working coil 120 and the second working coil 130, thereby making it possible to adjust the outputs of the first working coil and the second working coil differently and ensure improvement in the current conversion circuit's efficiency.

An object of the present disclosure is to provide an induction heating apparatus and a method for controlling the same in which a plurality of working coils is disposed on a single working coil base, thereby making it possible to use all the plurality of working coils regardless of the size of an object to be heated.

An object of the present disclosure is to provide an induction heating apparatus and a method for controlling the same in which connection relationships among a plurality of working coils are adjusted depending on the type of an object to be heated, thereby making it possible to adjust the outputs of the working coils differently.

An object of the present disclosure is to provide an induction heating apparatus and a method for controlling the same in which connection relationships among a plurality of working coils are adjusted depending on a target output value, thereby making it possible to improve the efficiency of a current conversion circuit that supplies current to working coils.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

According to the present disclosure, an induction heating apparatus includes a working coil base that accommodates a first working coil and a second working coil, a first relay that adjusts a connection between the other end of the first working coil and a resonance capacitor, and a second relay that selectively connects one end of the second working coil to any one of the other end of the first working coil and a current conversion circuit.

In the above configurations, connection relationships among a plurality of working coils may be adjusted.

In one embodiment, the induction heating apparatus may include a current conversion circuit that converts current supplied from an external power source, a first working coil whose one end is connected to the current conversion circuit, a second working coil whose one end is connected to the current conversion circuit or the other end of the first working coil, a resonance capacitor that connects to the other end of the second working coil, a first relay that adjusts a connection between the other end of the first working coil and the resonance capacitor, a second relay that selectively connects one end of the second working coil to any one of the other end of the first working coil and the current conversion circuit, and a controller that controls the first relay's and the second relay's connections.

In one or more embodiments, a working coil base may be provided that accommodates the first working coil and the second working coil.

In one embodiment, the first working coil and the second working coil of the induction heating apparatus may be coupled to each other as a litz wire structure and accommodated in the working coil base.

In one embodiment, the first working coil of the induction heating apparatus may be accommodated in the working coil base in a way that the first working coil is disposed on or under the second working coil.

In one embodiment, the first working coil and the second working coil of the induction heating apparatus may be accommodated in the working coil base in a way that a turn of the first working coil and a turn of the second working coil are alternately placed.

In one embodiment, the controller of the induction heating apparatus may control the first relay's and the second relay's connections. So, the controller may control whether a relay is turned off (Open) or turned on (closed) or whether a relay is connected to one or another terminal.

The control of the relay's may be based on at least one of the type of an object to be heated placed on the induction heating apparatus and/or a target output value.

In one embodiment, when the object to be heated placed on the induction heating apparatus is a ferromagnetic object to be heated and when the target output value is a predetermined reference output value or greater, the controller of the induction heating apparatus may control the first relay such that the first relay connects between the other end of the first working coil and the resonance capacitor, and controls the second relay such that the second relay connects between one end of the second working coil and the current conversion circuit.

In one embodiment, when the object to be heated placed on the induction heating apparatus is a ferromagnetic object to be heated and when the target output value is less than the predetermined reference output value, the controller of the induction heating apparatus may control the first relay such that the first relay does not connect between the other end of the first working coil and the resonance capacitor, and controls the second relay such that the second relay connects between one end of the second working coil and the other end of the first working coil.

In one or more embodiments, the controller may control the first and second relay to connect the first and second working coil in parallel or in series.

In one embodiment, when the object to be heated placed on the induction heating apparatus is an anti-ferromagnetic object to be heated, the controller of the induction heating apparatus may control the first relay such that the first relay does not connect between the other end of the first working coil and the resonance capacitor, and controls the second relay such that the second relay connects between one end of the second working coil and the other end of the first working coil.

In another embodiment, a method for controlling an induction heating apparatus, including a current conversion circuit that converts current supplied from an external power source, a first working coil whose one end is connected to the current conversion circuit, a second working coil whose one end is connected to the current conversion circuit or the other end of the first working coil, a working coil base that accommodates the first working coil and the second working coil, a resonance capacitor that connects to the other end of the second working coil, a first relay that adjusts a connection between the other end of the first working coil and the resonance capacitor, a second relay that selectively connects one end of the second working coil to any one of the other end of the first working coil and the current conversion circuit, and a controller, may include determining the type of an object to be heated placed on the induction heating apparatus by the controller, determining a target output value by the controller, and controlling the first relay's and the second relay's connections by the controller, based on at least one of the type of the object to be heated placed on the induction heating apparatus and the target output value.

In another embodiment, controlling the first relay's and the second relay's connections in the method may include when the controller determines that the object to be heated placed on the induction heating apparatus is a ferromagnetic object to be heated and determines that the target output value is a predetermined reference output value or greater, controlling the first relay by the controller such that the first relay connects between the other end of the first working coil and the resonance capacitor, and when the controller determines that the object to be heated placed on the induction heating apparatus is a ferromagnetic object to be heated and determines that the target output value is the predetermined reference output value or greater, controlling the second relay by the controller such that the second relay connects between one end of the second working coil and the current conversion circuit.

In another embodiment, controlling the first relay's and the second relay's connections in the method may include when the controller determines that the object to be heated placed on the induction heating apparatus is a ferromagnetic object to be heated and determines that the target output value is less than the predetermined reference output value, controlling the first relay by the controller such that the first relay does not connect between the other end of the first working coil and the resonance capacitor, and when the controller determines that the object to be heated placed on the induction heating apparatus is a ferromagnetic object to be heated and determines that the target output value is less than the predetermined reference output value, controlling the second relay by the controller such that the second relay connects between one end of the second working coil and the other end of the first working coil.

In another embodiment, controlling the first relay's and the second relay's connections in the method may include when the controller determines that the object to be heated placed on the induction heating apparatus is an anti-ferromagnetic object to be heated, controlling the first relay by the controller such that the first relay does not connect between the other end of the first working coil and the resonance capacitor, and when the controller determines that the object to be heated placed on the induction heating apparatus is an anti-ferromagnetic object to be heated, controlling the second relay by the controller such that the second relay connects between one end of the second working coil and the other end of the first working coil.

In an induction heating apparatus and a method for controlling the same according to the present disclosure, a first working coil and a second working coil are disposed in a single working coil base, thereby making it possible to use all the working coils regardless of the size of an object to be heated.

In the induction heating apparatus and the method for controlling the same, a connection relationship between the first working coil and the second working coil can be adjusted by changing a connection relationship between a first relay and a second relay depending on the type of an object to be heated, thereby making it possible to adjust the outputs of the working coils differently.

In the induction heating apparatus and the method for controlling the same, a connection relationship between the first working coil and the second working coil is adjusted by changing a connection relationship between a first relay and a second relay depending on a target output value, thereby making it possible to improve the efficiency of a current conversion circuit.

The embodiments are described above with reference to a number of illustrative embodiments thereof. However, the present disclosure is not intended to limit the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An induction heating apparatus, comprising:
a current conversion circuit configured to convert current from an external power source;
a first working coil having a first end to connect to the current conversion circuit;
a second working coil having a first end to connect to the current conversion circuit or to a second end of the first working coil;
a working coil base configured to accommodate the first working coil and the second working coil;
a resonance capacitor that connects to a second end of the second working coil;
a first relay configured to control a connection between the second end of the first working coil and the resonance capacitor;
a second relay that selectively connects the first end of the second working coil to any one of the second end of the first working coil and the current conversion circuit; and
a controller configured to control connections of the first relay and the second relay.

2. The induction heating apparatus of claim 1, wherein the first working coil and the second working coil are coupled to each other as a Litz wire structure, and the first working coil and the second working coil are accommodated on the working coil base.

3. The induction heating apparatus of claim 1, wherein the first working coil is accommodated on the working coil base such that the first working coil is disposed on the second working coil.

4. The induction heating apparatus of claim 1, wherein the first working coil is accommodated on the working coil base such that the second working coil is disposed on the first working coil.

5. The induction heating apparatus of claim 1, wherein the first working coil and the second working coil are accommodated on the working coil base such that a turn of the first working coil and a turn of the second working coil are alternately provided.

6. The induction heating apparatus of claim 1, wherein the controller is configured to control connections of the first relay and the second relay based on at least one of a type of an object to be heated that is provided on the induction heating apparatus and a target output value.

7. The induction heating apparatus of claim 6, wherein when the object to be heated that is provided on the induction heating apparatus is determined to be a ferromagnetic object to be heated and when the target output value is a predetermined reference output value or greater, the controller is configured to control the first relay such that the first relay connects between the second end of the first working coil and the resonance capacitor, and is configured to control the second relay such that the second relay connects between the first end of the second working coil and the current conversion circuit.

8. The induction heating apparatus of claim 6, wherein when the object to be heated that is provided on the induction heating apparatus is determined to be a ferromagnetic object to be heated and when the target output value is less than the predetermined reference output value, the controller is configured to control the first relay such that the first relay does not connect between the second end of the first working coil and the resonance capacitor, and is configured to control the second relay such that the second relay connects between the first end of the second working coil and the second end of the first working coil.

9. The induction heating apparatus of claim 6, wherein when the object to be heated that is provided on the induction heating apparatus is determined to be an anti-ferromagnetic object to be heated, the controller is configured to control the first relay such that the first relay does not connect between the second end of the first working coil and the resonance capacitor, and is configured to control the second relay such that the second relay connects between the first end of the second working coil and the second end of the first working coil.

10. A method for controlling an induction heating apparatus that includes a current conversion circuit that converts current from an external power source, a first working coil having a first end to connect to the current conversion circuit, a second working coil having a first end to connect to the current conversion circuit or to a second end of the first working coil, a working coil base that accommodates the first working coil and the second working coil, a resonance capacitor that connects to a second end of the second working coil, a first relay that controls a connection between the second end of the first working coil and the resonance capacitor, a second relay that selectively connects the first end of the second working coil to any one of the second end of the first working coil and the current conversion circuit, and a controller, the method comprising:
determining, by the controller, a type of an object to be heated that is provided on the induction heating apparatus;
determining, by the controller, a target output value; and
controlling, by the controller, connections of the first relay and the second relay, based on at least one of the determined type of the object to be heated that is provided on the induction heating apparatus and the target output value.

11. The method of claim 10, wherein the controlling of the connections of the first relay and the second relay, comprising:
when the controller determines that the object to be heated that is provided on the induction heating apparatus is a ferromagnetic object to be heated and determines that the target output value is a predetermined reference output value or greater, controlling, by the controller, the first relay such that the first relay connects between the second end of the first working coil and the resonance capacitor; and
when the controller determines that the object to be heated that is provided on the induction heating apparatus is a ferromagnetic object to be heated and determines that the target output value is the predetermined reference output value or greater, controlling, by the controller, the second relay such that the second relay connects between the first end of the second working coil and the current conversion circuit.

12. The method of claim 10, wherein the controlling of the connections of the first relay and the second relay, comprising:
when the controller determines that the object to be heated that is provided on the induction heating apparatus is a ferromagnetic object to be heated and determines that the target output value is less than the predetermined reference output value, controlling, by the controller, the first relay such that the first relay does not connect between the second end of the first working coil and the resonance capacitor; and
when the controller determines that the object to be heated that is provided on the induction heating apparatus is a ferromagnetic object to be heated and determines that the target output value is less than the predetermined reference output value, controlling, by the controller, the second relay such that the second relay connects between the first end of the second working coil and the second end of the first working coil.

13. The method of claim 10, wherein the controlling of the connection of the first relay and the second relay, comprising:
when the controller determines that the object to be heated that is provided on the induction heating apparatus is an anti-ferromagnetic object to be heated, controlling, by the controller, the first relay such that the first relay does not connect between the second end of the first working coil and the resonance capacitor; and
when the controller determines that the object to be heated that is provided on the induction heating apparatus is an anti-ferromagnetic object to be heated, controlling, by the controller, the second relay such that the second relay connects between the first end of the second working coil and the first end of the first working coil.

14. An induction heating apparatus, comprising:
a current conversion circuit configured to provide current;
a first working coil to couple to the current conversion circuit;
a second working coil to couple to the current conversion circuit or to the first working coil;
a working coil base configured to support the first working coil and the second working coil;
a resonance capacitor that couples to the second working coil;
a first relay configured to control a connection between the first working coil and the resonance capacitor;
a second relay that selectively connects the second working coil to any one of the first working coil and the current conversion circuit; and
a controller configured to control connections of the first relay and the second relay based at least on a type of an object to be heated.

15. The induction heating apparatus of claim 14, wherein:
the first working coil having a first end to connect to the current conversion circuit;
the second working coil having a first end to connect to the current conversion circuit or to a second end of the first working coil;
the resonance capacitor that connects to a second end of the second working coil;
the first relay is configured to control a connection between the second end of the first working coil and the resonance capacitor;
the second relay is configured to selectively connect the first end of the second working coil to any one of the second end of the first working coil and the current conversion circuit.

16. The induction heating apparatus of claim 15, wherein the first working coil and the second working coil are coupled to each other as a Litz wire structure, and the first working coil and the second working coil are accommodated on the working coil base.

17. The induction heating apparatus of claim 15, wherein the first working coil is accommodated on the working coil base such that the first working coil is disposed on the second working coil or the first working coil is disposed under the second working coil.

18. The induction heating apparatus of claim 15, wherein when the object to be heated that is provided on the induction heating apparatus is determined to be a ferromagnetic object to be heated and when a target output value is a predetermined reference output value or greater, the controller is configured to control the first relay such that the first relay connects between the second end of the first working coil and the resonance capacitor, and is configured to control the second relay such that the second relay connects between the first end of the second working coil and the current conversion circuit.

19. The induction heating apparatus of claim 15, wherein when the object to be heated that is provided on the induction heating apparatus is determined to be a ferromagnetic object to be heated and when a target output value is less than a predetermined reference output value, the controller is configured to control the first relay such that the first relay does not connect between the second end of the first working coil and the resonance capacitor, and is configured to control the second relay such that the second relay connects between the first end of the second working coil and the second end of the first working coil.

20. The induction heating apparatus of claim 15, wherein when the object to be heated that is provided on the induction heating apparatus is determined to be an anti-ferromagnetic object to be heated, the controller is configured to control the first relay such that the first relay does not connect between the second end of the first working coil and the resonance capacitor, and is configured to control the second relay such that the second relay connects between the first end of the second working coil and the second end of the first working coil.
